(19) United States
(12) Patent Application Publication
(10) Pub. No.: US 2010/0174681 A1
(43) Pub. Date: Jul. 8, 2010

(54) METHOD AND DEVICE FOR HETEROGENEOUS DATABASE SYNCHRONIZATION

(75) Inventors: Dominique Nadaire, Machemont (FR); Tatiana Nadaire-Maya, Machemont (FR)

Correspondence Address: HARNESS, DICKEY & PIERCE, P.L.C., P.O. BOX 828, BLOOMFIELD HILLS, MI, 48303, US

(73) Assignee: SERLIVE, Machemont (FR)

(21) Appl. No.: 12/516,087

(22) PCT Filed: Nov. 23, 2007
(86) PCT No.: PCT/FR2007/001931

§ 371 Date: Mar. 10, 2010

(30) Foreign Application Priority Data
Nov. 23, 2006 (FR) 0610257

(51) Int. Cl. G06F 17/30

(52) U.S. Cl. 707/635; 707/E17.005; 707/769; 707/E17.014

(57) ABSTRACT

The present application relates to a method for synchronizing heterogeneous databases using at least one processor, a first user database, a second user registers database, a third location criteria database and a fourth location occupancy database, the inputs of said first user database being likely to match the inputs of the third location criteria database, with the method including:
a step of modification wherein the inputs of the fourth location occupancy database and the inputs of the second user register database are modified in response to a request;
prior to the modification, the processor processes the request so as to check the matching between the inputs of the third location criteria database and the inputs of the first user database;
depending on the checking, the processor sends a positive acknowledgement to the first location occupancy database and to the second user register database so as to carry out the modification.

### CROSS-REFERENCE TO RELATED APPLICATIONS

This application is a National Phase Entry of International Application No. PCT/FR2007/001931, filed Nov. 23, 2007, which claims priority to French Patent Application No. 06/10257, filed Nov. 23, 2006, both of which are incorporated herein by reference.

### BACKGROUND AND SUMMARY

The present invention relates to a solution for consulting, editing, updating and synchronizing a set of heterogeneous databases and provides a method and a system for synchronizing databases some information from one or several of said databases are independent of some other information from one or several other databases.

The general problem is to provide a device able to synchronize and update a set of heterogeneous and independent databases. A set of heterogeneous databases which are not automatically synchronized today is to be found in the sport clubs where it is necessary to manage on the one hand databases of the sports' club members and on the other hand a set of databases relating to the booking and the occupancy of the locations such as sports rooms and fields, tennis courts, teeing grounds on a golf course or strengthening equipment. In addition, club members do not know each other very well and a request from the members is to have the possibility of meeting and playing with new partners. The optional booking of a location and the seeking of partners is a service which must be rendered by the method for synchronizing heterogeneous databases.

From document EP 16844194 (SAP AG) a central synchronization service is known for applications of the database type. However, the method described does not allow adapting to applications such as the booking of sport fields so as temporarily or definitely put aside a location for a given user. In addition, document WO2005055083 (Thomson Licensing SA) describes a device and a method for retrieving information from a database. This method does not make it possible to take into consideration successive determination parameters such as for example the utilization of a badge or a chip card to authorize access to the location booked.

In order to remedy these various defects, the invention relates, in its broadest sense, to a method for synchronizing a set of heterogeneous databases and provides a method and a system for the synchronization of databases from which some information from one or several databases depends on some other information from one or several other databases. The invention relates to a method for synchronizing heterogeneous databases using at least one processor, a first user database, a second user register database, a third location criteria database and a fourth location occupancy database, the inputs of the first user database being likely to match the inputs of the third location criteria database, the method including:

A step of modification during which inputs of the fourth location occupancy database and inputs of the second user register database are modified in answer to a request; wherein,

prior to said modification, the processor processes the request so as to check the matching between the inputs of the third location criteria database and the inputs of the first user database;

as a function of the checking, the processor transmits a positive acknowledgement to the fourth location occupancy database and to the second user register database so as to carry out the modification.

Preferably, the inputs of the first user database include user subscription parameters and the inputs of the third location criteria database include parameters associated with the locations, a step during which the processor processes the request so as to check the matching between the inputs of the third location criteria database and the inputs of the first user database including a step during which the processor checks that the location is accessible to a user as a function of the user subscription parameters and the parameters associated with the location. In addition, advantageously, the inputs of the first user database include at least one user identifier and the subscription parameters include at least tennis court types accessible through the subscription and the inputs of the third location criteria database include at least types of tennis courts. Preferably, the inputs of the fourth location occupancy database include, for each tennis court, at least a time slot for the booking of the tennis court by users, and the inputs of the second user register database include, for each user, at least one tennis court reserved by the user for a time slot. Advantageously, said user database is completed by a user preferences database.

In a particular embodiment, some data of said location occupancy database are modified by data blocks. Advantageously, some data from said location occupancy database are modified by a user as a function of the parameters of said user database. Advantageously, some data of said location occupancy database are modified by a user as a function of the parameters of said location criteria database.

In another embodiment, said location occupancy database is synchronized with said user registers database. Advantageously, a user of said user database takes an option “Booked—Partner Wanted” in said location occupancy database. Advantageously, an e-mail is sent to the potential partners' terminals further to said option “Booked—Partner Wanted” in said location occupancy database. Advantageously, an SMS is sent to the potential partners' terminals further to said option “Booked—Partner Wanted” in said location occupancy database.

In addition, the invention relates to a system for synchronizing heterogeneous databases arranged for the implementation of a method, as previously described. Preferably, this system includes a server for the implementation of the method and at least one local network which a badge reader is connected to. Advantageously, the system further includes at least an acquisition and consulting terminal, connected to said local network. Advantageously, the access to a location is dependent on the reading of a user's badge, the information of said location occupancy database and information of said location criteria database.

### BRIEF DESCRIPTION OF DRAWING

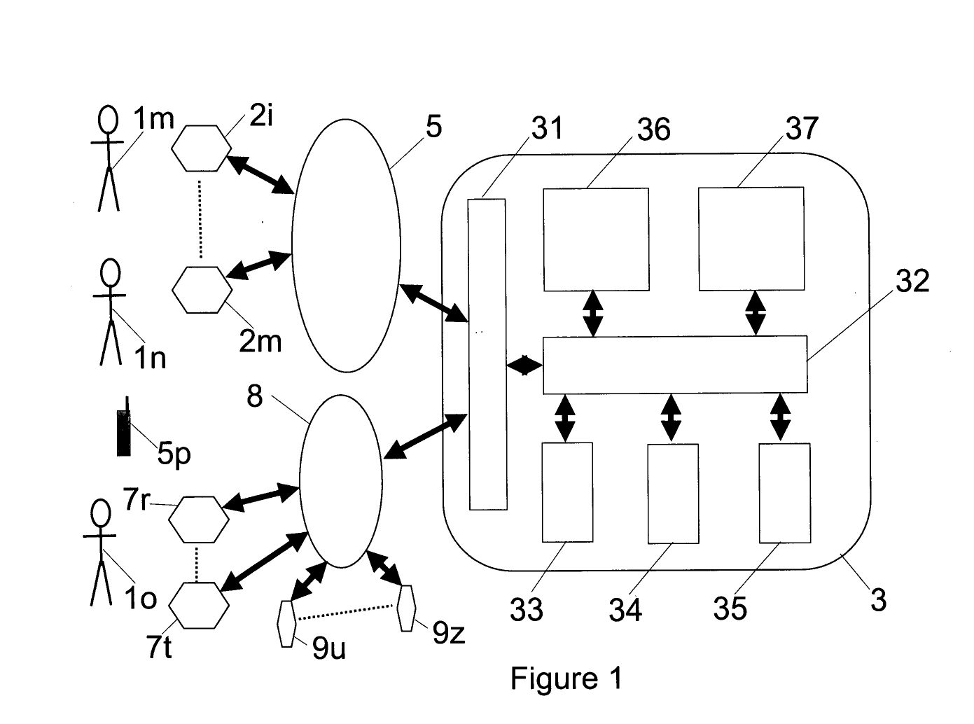

The present invention will be better understood when reading the description of a non limitative exemplary embodiment hereinunder, and referring to the appended drawing as FIG. 1, which describes the global architecture of a system for implementing the method according to the invention.

### DETAILED DESCRIPTION

In a first example, a user (1i) wishes to book a location which is a tennis court. Therefore, said user (1i) conventionally connects, via a terminal (2m), to the distant server (3) through a telecommunication network (9). Said server (3) contains all the databases corresponding to the personal data of said user (1i), as well as all the data on all the locations which are, in our example, tennis courts. As soon as the terminal (2m) is connected to the server (3), the processor (32) in said server (3) displays, via the network interface (31), and through the telecommunication network (9) a menu on the terminal screen (2m) in order to request the user (1i) of said terminal (2m) to identify himself or herself for example by entering his or her identifier and his or her password.

In a particular embodiment, the user identification (1i) is obtained through a badge reader or a chip card reader on the terminal (2m). As soon as the user (1i) is identified, said processor (32) displays, from the user database (34), the user's (1i) main parameters such as, for example, his or her name, Christian name, address, classification, etc. In a particular embodiment, said processor (32) displays, from the players booking users register database (33) all the bookings already made by said user (1i). In another embodiment, said processor (32) displays, from the location occupancy database (37), all the courts available on this server. The location occupancy database (37) includes, for each court, the occupancy level: occupied, free, option, booked, etc.

Advantageously, said processor (32) displays, from the location occupancy database (37), all the occupied courts. Advantageously, the names and photographs of the players having made a booking for each location are displayed on the terminal (2m) screen. Advantageously, the number and/or all the names of the players corresponding to each booking are displayed on the terminal (2m) screen. Advantageously, all the bookings made by said user (1i) are displayed with a customized color for said user (1i).

To book a court, a user (1i) positions, for example, the terminal (2m) mouse on the block corresponding to the court, the day and the time he or she has selected. The processor (32) then checks that the user (1i) parameters allow him to reserve said court at this time of this day. Therefore, the processor (32) reads, on the one hand, the location criteria database (36) which contains, for each court, the locations, the generic availability, such as indoor tennis court, crude earth or grass field, reserved to professionals, reserved to such classification etc., and on the other said user (1i) parameters from the user database (34).

Advantageously, said user database (34) contains the subscription form as a club member such as for example:

The period of utilization;

Summer package;

School year package;

Season package;

Etc.;

The location, since some packages are valid for certain courts only;

The type;

Periodical subscription;

Pay per play subscription;

A few hours user plan.

If the user (1i) parameters and the court criteria are compatible, the booking of said court is confirmed by the processor (32) which sends a positive acknowledgement to the players booking user register database (33) as well as to the location occupancy database (37). Said processor (32) then updates and synchronizes said players booking user register database (33) as well as said location occupancy database (37) which mentions that this court is booked by said user (1i) on such day for such time slot.

In another embodiment, a user calls one manager of said location occupancy database (37) and requests said manager to reserve a court for him for such day and at such time. In another embodiment, the manager of said location occupancy database (37) modifies the occupancy condition of a court by blocks, such as for example the court is booked and occupied for a competition at every time slot, for four days. In another example, a manager of said location occupancy database (37) modifies the occupancy condition of a court for such hour, every day of the week.

At any time, a user (1i, 1j, 1k, etc.) can cancel a booking he/she made. In this case, the booking is deleted by the processor (32) which synchronizes said players' booking user register database (33) and said location occupancy database (37). In another embodiment, a user (1o) uses a terminal (7r) to make said booking. The terminals (4r, 7t, etc.) are connected to the data server (3) by the local network (8). In another example, another user (1j) wishes to have one or several game partners to play tennis.

Therefore, said user (1j) conventionally connects via a terminal (2n) to a distant server (3). As soon as the terminal (2n) is connected to the server (3), the processor (32) of said server (3) displays a menu on the terminal screen (2n), in order to request a user thereof (1j) to identify himself or herself. Said processor (32) displays, from the user database (34), the user (1j) main parameters, all the bookings he already made or made by said user (1j), as well as all the courts available on this server from the location occupancy database (37). To find a partner, said user (1j) selects the “Partner wanted” option and positions on the block corresponding to the court, the time and the day he wishes or she wishes. Advantageously, said user (1j) mentions how many partners he wants, if he/she wishes to play against a man or a woman in singles or doubles games, etc.

The processor (32) checks that said user (1i) parameters enable him/her to seek one or several partners for said court, at that time of that day. Therefore, the processor (32) reads the location criteria database (36) and said user (1j) parameters from the user database (34). If said user (1j) parameters and the court criteria are compatible, the search for partners is accepted by the processor (32) and said court is reserved with the option “Partner Wanted” said processor (32) updates and then synchronizes said player booking user registers database (33) as well as the location occupancy database (37). Advantageously, the courts which are occupied with the option “Partner Wanted” are displayed in another color than the occupied or free courts.

In a particular implementation, the processor (32) reads the players preference database (35) which corresponds to each player's preference such as for example the courts on which he wishes to play, in a preference ordering. Advantageously, said players' preference database (35) contains the list of the partners with whom he/she would like to play, preferably. Advantageously, said players' preferences database (35) contains, for each player, the preferred days and time slots.

From the information of said players' preferences database (35), the processor (32) first displays said users (2n) preferred courts in order to simplify, for said user (2n), the selection of the courts for the selected day. Advantageously, said user (2n) selects one or several users among his or her preferred partners. Advantageously, said user (2n) selects a partner who is not on his or her privileged partners list but in one list of players who have an equivalent playing level.

In a particular embodiment, as soon as the “Partners Wanted” option is activated, the processor (32) automatically sends an electronic message of the e-mail type or SMS type to the terminal or terminals of the preferred partners of said user (2n). For example, if a preferred partner of said user (2n) has a mobile telephone (5p), the processor (32) automatically sends an SMS to said terminal (5p) indicating that said user (2n) wishes to play with him or her, on such day at such time on such court. Advantageously, the processor (32) completes the SMS sent with a request for an answer through a simple action on his or her telephone. The user of said terminal (5p) accepts or rejects this invitation.

In another embodiment, if a preferred partner of said user (2n) has a terminal of the PC type, the processor (32) automatically sends an email to the terminal of said partner indicating that said user (2n) wishes to play with him or her on such day at such time on such court. The processor (32) completes said sent e-mail with one request for an answer through a simple action of his or her PC. The user of said PC accepts or rejects the invitation. If the invitation is accepted, the processor (32) confirms the booking, updates and synchronizes said players' booking user register database (33) for the two users (2n) and (5p) as well as the location occupancy database (37) which switches from the “Partners Wanted” option condition to the Booked condition.

In another embodiment, the interface (31) is connected to a local network (8) which is itself connected to terminals (7r, 7t, etc.) such as PC or local multimedia terminals. Said terminals (7) are then used as acquisition and consulting terminals for the server databases (3).

In a particular embodiment, the access to the tennis court is checked by a magnetic badge reader or a chip card reader (9u, . . . , 9z) connected to said local network (8), for example at the entrance door to each court. Only the users (1) who booked the court can access the court. Said user (1i) identifies himself or herself thanks to the badge reader (9u) corresponding to the court he or she booked, and the processor (32) checks via said location occupancy database (37) and said users database (34) whether said user (1i) can enter said court, checked by the badge reader (9u). The access to a location depends on the reading on the user's badge, information from said location occupancy database (37) and information from said criteria database (36). Advantageously, the access to said booked court is possible only within a time slot between, for example, 10 nm before and 10 nm after the booked time slot as indicated in said location occupancy database (37).

Another example relates to the utilization of said method for booking golf courses teeing grounds. In this case, said user database relates to golf players, said user register database is used for recording the time of beginning, said location criteria database described the set of golf course with the characteristics thereof and said location occupancy database indicates for all the golf course each occupation at each start from each hole.

1. A method for synchronizing heterogeneous databases with at least one processor, a first user database, a second user register database, a third location criteria database and a fourth location occupancy database, the inputs of the first user database being liable to match the inputs of the third location criteria database, the method comprising:
(a) a step of modification, during which the inputs of the fourth location occupancy database and the inputs of the second user register database are modified in response to a request;
(b) prior to said modification, the processor processes the request so as to check the matching between the inputs of the third location criteria database and the inputs of the first user database; and
(c) depending on the result of the checking, the processor transmits a positive acknowledgement to the fourth location occupancy database and to the second user register database so as to carry out the modification.

2. A method according to claim 1, wherein the inputs of the first user database include user subscription parameters and the inputs of the third location criteria database include parameters associated with the locations, the step during which the processor processes the request so as to check the matching between the inputs of the third location criteria database and the inputs of the first user database including a step during which the processor checks that a location is accessible to a user depending on the user subscription parameters and the parameters associated with the location.

3. A method according to claim 2, wherein the inputs of the first user database include at least one user identifier and the subscription parameters include at least types of tennis courts accessible through the subscription and the inputs of the third location criteria database include at least types of tennis courts.

4. A method according to claim 1, wherein the inputs of the fourth location occupancy database include for each tennis court at least a time slot for the booking of the tennis court by users and the inputs of the second user registers database include, for each user, at least a tennis court booked by the user for a time slot.

5. A method according to claim 1, further comprising completing said user database by a user preferences database.

6. A method according to claim 1, further comprising modifying certain data of said location occupancy database by data blocks.

7. A method according to claim 1, further comprising modifying certain data of said location occupation database by a user as a function of the parameters of said user database.

8. A method according to claim 1, further comprising modifying certain data of said location occupancy database by a user as a function of the parameters of said location criteria database.

9. A method according to claim 1, further comprising synchronizing said location occupancy database with said user register database.

10. A method according to claim 1, further comprising one user of said user database taking an option with partner “Booked—Partner Wanted” in said location occupancy database.

11. A method according to claim 1, further comprising sending an e-mail to the potential partners' terminals further to said option “Booked—Partner Wanted” in said location occupancy database.

12. A method according to claim 7, further comprising sending an SMS to the potential partners' terminals further to said option “Booked—Partner Wanted” in said location occupancy database.

13. A system according to claim 1, further comprising a server and at least one local network which at least one badge reader is connected to.

14. A system according to claim 13, further comprising at least one acquisition and consulting terminal, connected to said local network.

15. A system according to claim 13, wherein the access to a location depends on the reading of a user badge, to the information of said location occupancy database and to information from said location criteria database.
